(19) United States
(12) Patent Application Publication
(10) Pub. No.: US 2015/0040159 A1
(43) Pub. Date: Feb. 5, 2015

(54) METHODS AND SYSTEMS FOR DISPLAYING SCHEDULED EVENTS IN A MEDIA GUIDANCE DISPLAY

(71) Applicant: United Video Properties, Inc., Santa Clara, CA (US)

(72) Inventor: Suwen Yuan, Hangzhou (CN)

(73) Assignee: United Video Properties, Inc., Santa Clara, CA (US)

(21) Appl. No.: 13/955,239

(22) Filed: Jul. 31, 2013

(51) Int. Cl. H04N 21/458; H04N 21/482; H04N 21/462; H04N 21/472; H04N 21/431; H04N 21/433

(52) U.S. Cl. CPC H04N 21/458; H04N 21/4316; H04N 21/4334; H04N 21/4622; H04N 21/47202; H04N 21/47214; H04N 21/4821
USPC 725/40

(57) ABSTRACT

Methods and systems are disclosed herein for a media guidance application that provides media guidance data in which media providers are filtered according to whether or not a media listing associated with the media provider corresponds to a scheduled event. For example, in response to a user request to view scheduled recordings, the media guidance application generates a media guidance display featuring only media providers associated with scheduled recordings. For those media providers, the media guidance application provides both media listings scheduled to be recorded and media listings not currently scheduled to be recorded.

### BACKGROUND

In conventional systems, users typically have a plethora of media content available for their viewing. For example, typical cable and satellite systems often offer users hundreds of broadcast channels. Users also have the ability to record programming on the numerous channels (e.g., through the use of a digital video recording system). Furthermore, many systems allow a user to record a program without knowing the scheduled broadcast time of the program. For example, a user may establish a series recording that records each episode of a program regardless of when it airs. However, after scheduling recordings, users have limited abilities to review and manage the scheduled recordings.

### SUMMARY

Accordingly, methods and systems are disclosed herein for a media guidance application that provides media guidance data in which media providers are filtered according to whether or not a media listing associated with the media provider corresponds to a scheduled event. For example, in response to a user request to view scheduled events, the media guidance application generates a media guidance display featuring only media providers associated with scheduled events. For those media providers, the media guidance application provides both media listings with scheduled events and media listings without scheduled events. Advantageously, a user may then edit his/her scheduled events using an intuitive interface.

For example, the media guidance application may filter media providers based on whether or not a media provider is associated with a media listing that is scheduled to be recorded during a portion of time. If the media provider is associated with a media listing that is scheduled to be recorded during the portion of time, the media guidance application generates for display both media listings associated with the media provider that are scheduled to be recorded during the portion of time and media listings associated with the media provider that are not scheduled to be recorded during the portion of time.

Filtering the media providers may result in removing from display media providers that do not have a media listing corresponding to a scheduled event during the portion of time; consequently, a user does not need to waste time and/or energy navigating (e.g., scrolling vertically and horizontally) through media providers that do not correspond to the scheduled event. In contrast, the media providers that are generated for display correspond to media providers that do have media listings corresponding to the scheduled event during the portion of time. Consequently, the user may edit (e.g., add or remove) the status of a scheduled event (e.g., indicated to a user via a scheduling indicator) associated with the generated media listings.

The media guidance application may also provide options (e.g., edit/add/remove a scheduled event, edit a portion of time associated with the generation of media listings, present particular media listings, etc.) associated with any media listings generated for display. The options may appear as icons in a menu, or may be based on the timing and type of a user input.

In some aspects, the media guidance application generates for display a first plurality of media listings, in which the first plurality of media listings correspond to media listings available from a plurality of media providers during a portion of time. The media guidance application then (e.g., in response to a user filtering request) filters the plurality of media providers corresponding to the first plurality of media listings based on whether or not a first media listing of the first plurality of media listings available from a media provider of the plurality of media providers is corresponds to a scheduled event during the portion of time, and generates for display a second plurality of media listings featuring results of the filtering, in which the results of the filtering include the first media listing available from a filtered media provider that corresponds to a scheduled event during the portion of time and a second media listing available from the filtered media provider that does not correspond to a scheduled event during the portion of time.

In some aspects, the media guidance application generates the first plurality of media listings in a media grid. For example, the media gird may feature a first and second axis. The first axis of the media grid may correspond to the plurality of media providers and the second axis of the media grid may correspond to a portion of time. For example, the media grid may represent a series of cells, and each row of the media grid may correspond to a media provider, while each column may correspond to a particular time. The second plurality of media listings may preserve this organization, but remove excess media providers in order to provide only media listings associated with a media provider that corresponds to a scheduled event during the portion of time.

In some aspects, the media guidance application generates the first plurality of media listings in a mosaic guide. For example, the mosaic guide may feature a first and second area. The first area of the mosaic guide may correspond to the plurality of media providers and the second area of the mosaic guide may correspond to a portion of time. In response to a user filtering request, the media guidance application may remove media listings that are not associated with a media provider that corresponds to a scheduled event during the portion of time.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1A shows an illustrative example of a media guidance display with a plurality of media listings that may be filtered in accordance with some embodiments of the disclosure;

FIG. 1B shows an illustrative example of a media guidance display with a plurality of media listings, including some media listings associated with scheduled events, that may be filtered in accordance with some embodiments of the disclosure;

FIG. 1C shows an illustrative example of a media guidance display with a plurality of media listings filtered in accordance with some embodiments of the disclosure;

FIG. 2 shows another illustrative example of a media guidance display with a plurality of media listings that may be filtered in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a flowchart of illustrative steps for generating a plurality of media listings that are filtered based on whether or not a media listing of a media provider corresponds to a scheduled event during the portion of time in accordance with some embodiments of the disclosure; and

FIG. 6 is a flowchart of illustrative steps for filtering a plurality of media listings based on whether or not a media listing of a media provider corresponds to a scheduled event during the portion of time in accordance with some embodiments of the disclosure.

### DETAILED DESCRIPTION OF DRAWING

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Methods and systems are disclosed herein for a media guidance application that provides media guidance data in which media providers are filtered according to whether or not a media listing associated with the media provider corresponds to a scheduled event. As used herein, a “scheduled event” refers to any media guidance display operation that depends is triggered, at least in part, based on the current time corresponding to a predetermined time. For example, a scheduled event may include, but is not limited to, a scheduled recording, a reminder, an automatic account billing, etc. For example, a recording may be automatically initiated in response to the current time matching a predetermined “scheduled” time for the recording. It should be noted that any embodiment described below pertaining to one type of scheduled event (e.g., a scheduled recording) may also be applied to another type of scheduled event (e.g., a reminder).

In addition, any embodiment described below pertaining to a scheduled event may also be applied to any other filtering criteria. For example, the media guidance application may provide media guidance data in which media providers are filtered according to whether or not a media listing associated with the media provider corresponds to a genre, a favorite setting, a presence of a particular actor, a particular rating, a recommendation, and/or any other category of used to distinguish media listings and/or media assets.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

It should be noted that throughout this disclosure method and systems are described for filtering and/or generating media listings. It should be noted that this disclosure is not limited to filtering based on media providers associated with media listings scheduled events. For example, in some embodiments, categories (e.g., based on any type of the media guidance data described above) may be filtered based on whether or not they include a media listing that corresponds to a scheduled event.

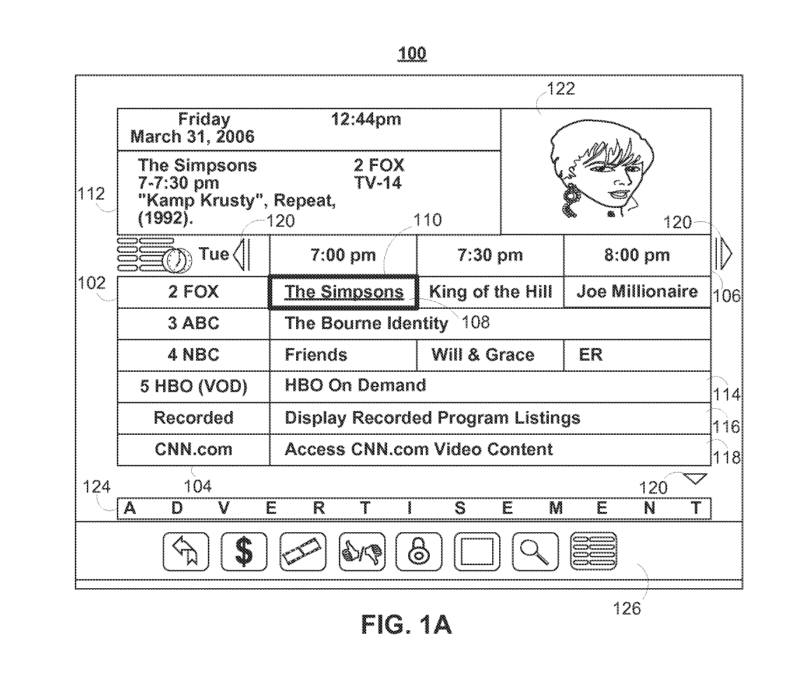

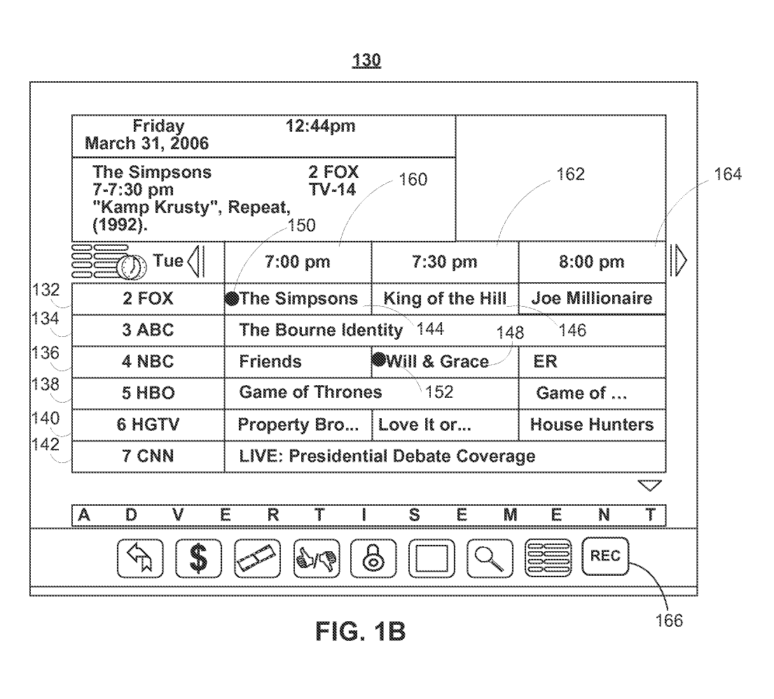

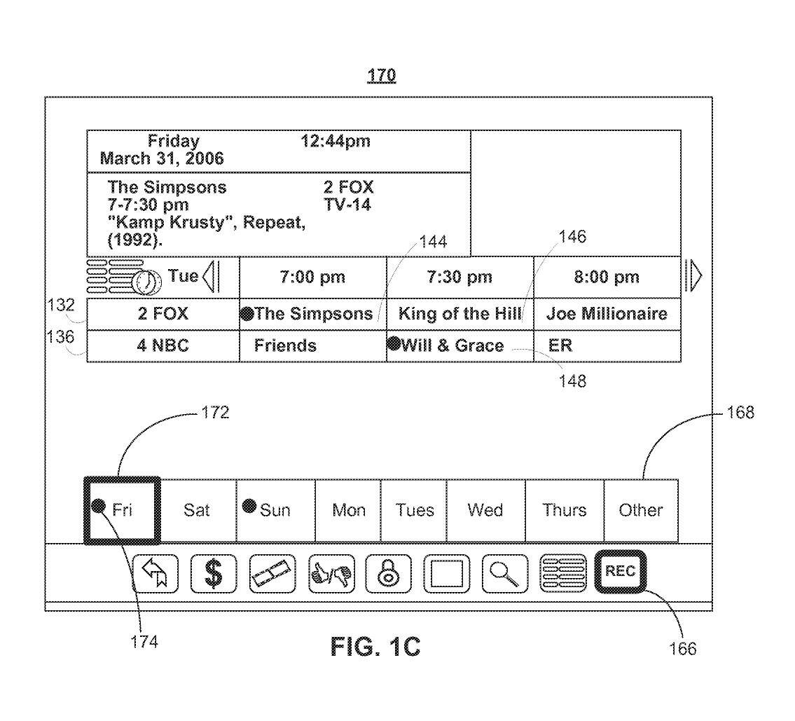

FIGS. 1A-C and 2 show illustrative display screens that may be used to provide media guidance data. The display screens shown in FIGS. 1A-C and 2 may be implemented on any suitable user equipment device or platform. While the displays of FIGS. 1A-C and 2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1A shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

FIG. 1B shows an illustrative example of a media guidance display with a plurality of media listings, including some media listings corresponding to scheduled events, that may be filtered. In some embodiments, display 130 may correspond to display 100 (FIG. 1A) after a user selects a media listing (e.g., program listing 108 (FIG. 1A)).

Display 130 includes a plurality of media listings corresponding to a plurality of media providers at different increments of times. For example, display 130 includes media providers 132, 134, 136, 138, 140, and 142 as well as the media listings (e.g., media listing 144, 146, and 148) that are associated with time increments 160, 162, and 164.

Time increments 160, 162, and 164 may constitute one or more portions of time. For example, in some embodiments, the media guidance application may generate for display a plurality of media listings (e.g., the media listings shown in display 130), in which the plurality of media listings correspond to media listings available from a plurality of media providers (e.g., media providers 132, 134, 136, 138, 140, and 142) during a portion of time (e.g., time increments 160, 162, and/or 164).

Display 130 currently displays a media guidance display in a media grid format. For example, the media gird features a first and second axis. The first axis of the media grid corresponds to a plurality of media providers (e.g., media providers 132, 134, 136, 138, 140, and 142) and the second axis of the media grid corresponds to a portion of time (e.g., represented by time increments 160, 162, and/or 164). The media listings (e.g., media listing 144, 146, and 148) represent cells in the grid. Each cell of the media grid corresponds to a media provider of the plurality of media providers and an increment of time of the portion of time.

The axes of the media grid provide criteria associated with the media listings in the grid. For example, in display 130, the intersection of a column, corresponding to a particular time (e.g., “7:00 PM”), and a row, corresponding to a particular media provider (e.g., “FOX”), is associated with a cell (e.g., associated with media listing 144) that is associated with both the particular time and the particular media provider (e.g., is presented at 7:00 PM on FOX).

Display 130 also includes indicators 150 and 152, which are associated with media listings 144 and 148, respectively. Indicators 150 and 152 indicate to a user that media listings 144 and 148 currently correspond to a scheduled event (e.g., a scheduled recording). It should be noted that although indicators 150 and 152 are shown as dark circles in display 130, any audio, video, and/or textual alert and or anything else that indicates to a user that a media listing corresponds to a scheduled event may constitute an indicator.

Display 130 also includes a plurality of options. For example, display 130 includes an options region (e.g., which in some embodiments may correspond to options region 126 (FIG. 1A)) featuring option 166. Option 166 represents an option for filtering the media providers in display 130 by removing from display media providers that do not have media listing scheduled to be recorded during the portion of time. For example, in response to a user input selecting option 166, the media guidance application may generate for display only media providers that have media listings scheduled to be recorded during the portion of time. Additionally or alternatively, display 130 may include additional options associated with other scheduled events and/or option 166 may generate for display any media providers that has a media listing corresponding to a scheduled event during the portion of time

It should be noted that the media guidance application may also provide other options. For example, the media guidance application may provide options to add or remove scheduled recordings and/or any other type of scheduled event. For example, to edit the portion of time associated with the generation of media listings (e.g., scroll to a time increment other than time increment 160, 162, or 164), to present particular media listings, or any other option typically associated with accessing or navigating to a media listing.

It should be noted that options associated with media listings (e.g., viewing, filtering, recording, etc.) may appear as icons in a menu (e.g., as shown in FIGS. 1A-C), or may be based on the timing and type of a user input. For example, in some embodiments, resting a highlight region (e.g., highlight region 110 (FIG. 1A)) over a media listing for a particular amount of time (e.g., two seconds) may trigger the media guidance application to perform an operation (e.g., schedule a recording, unscheduled a recording, generate for display additional information about a recording, schedule a reminder, etc.) even without a subsequent user input and/or selection. Additionally or alternatively, while a particular mode (e.g., a mode filtering media providers based on whether or not the media providers are associated with a media listing corresponding to a scheduled event), the media guidance application may respond to single inputs that may perform different functions based on a length of time associated with the input. For example, depressing a single input (e.g., on a user input interface) for two seconds may cause a recording to be scheduled, while depressing the input for four seconds may cause a recording to be canceled.

In some embodiments the media guidance application may allow a user to perform one-touch operations from menu screens or a filtered media guide displays. For example, after activating a menu or filtering a media guide, the media guidance application may allow the user to perform one-touch operations (e.g., play a media listing, schedule a recording, etc.). In some embodiments, the media guidance application may determine the particular one-touch options available based on criteria associated with a currently activated menu. For example, if a user currently has a recording options menu activated, the media guidance application may enable one-touch recording operations.

In some embodiments, the media guidance application may determine the particular one-touch options available based on criteria associated with filtered media guide display. For example, if a user has filtered the media guide based on whether or not a media listing corresponds to a “Favorite” of a user, the media guidance application may allow the user to add or remove a favorite listing through a one-touch option. In another example, if a user has filtered the media guide based on whether or not a media listing is scheduled for recording, the media guidance application may allow the user to add or remove a scheduled recording through a one-touch option.

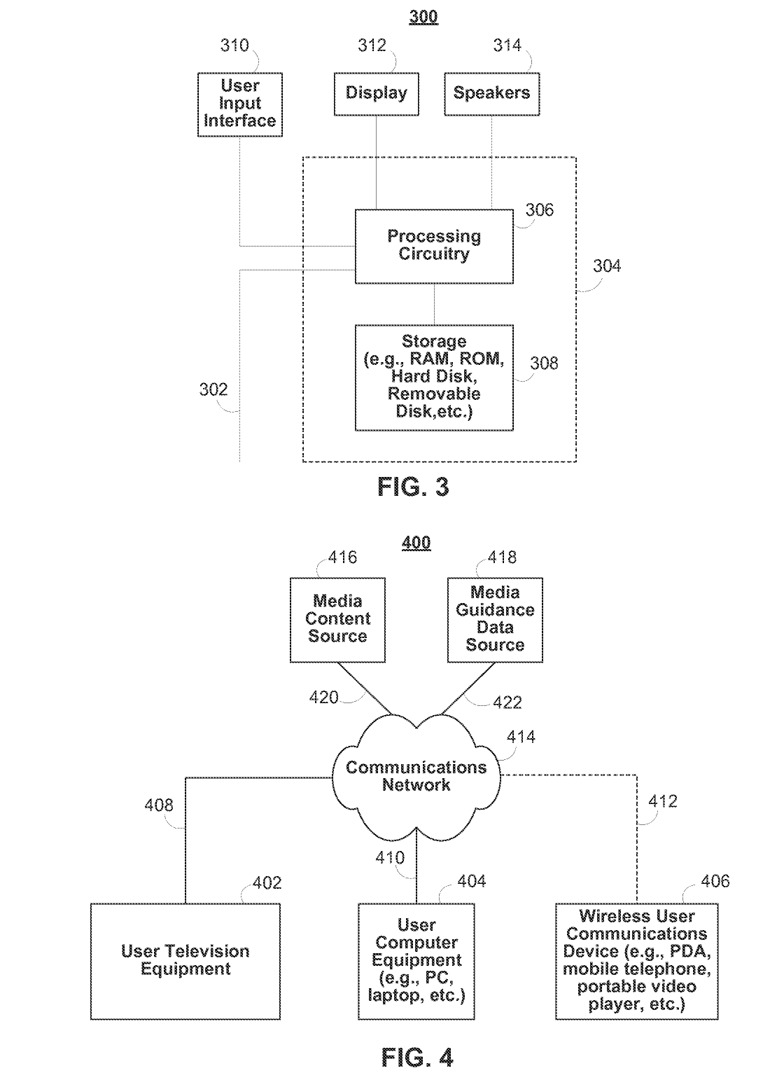

In another example, a particular type of input (e.g., a pinch-and-expand, swipe, shake, etc.) may trigger the media guidance application to perform an operation. For example, in response to a detecting a user input (e.g., via user input interface 310 (FIG. 3) below) associated with a pinch-and-zoom, the media guidance application performs a zoom-in operation on the media guidance application. Additionally or alternatively, in response to detecting a user input associated with shaking or waving a user device (e.g., via a motion control sensor incorporated into a user device), the media guidance application may schedule a reminder for a highlighted media listing.

FIG. 1C shows an illustrative example of a media guidance display that is filtered. For example, in some embodiments, display 170 may represent display 130 (FIG. 1B) after a user has selected option 166. As shown in display 170, option 166 is currently highlighted indicating that a user has selected option 166. In response to detecting the selection of option 166, the media guidance application has generated the plurality of media listings shown in display 170.

In display 170, the media guidance application has (e.g., in response to a user filtering request) filtered a plurality of media providers corresponding to a first plurality of media listings (e.g., the media listings shown in display 130 (FIG. 1B)) based on whether or not a first media listing of the first plurality of media listings available from a media provider of the plurality of media providers (e.g., media providers 132, 134, 136, 138, 140, and 142 (FIG. 1B)) is scheduled to be recorded during the portion of time (e.g., a portion of time associated with time increments 160, 162, and 164 (FIG. 1C)), and has generated for display a second plurality of media listings (e.g., the media listings shown in display 170) featuring the results of the filtering, in which the results of the filtering include a first media listing (e.g., media listing 144) available from a filtered media provider (e.g., media provider 132) that is scheduled to be recorded during the portion of time and a second media listing (e.g., media listing 146) available from the filtered media provider that is not scheduled to be recorded during the portion of time.

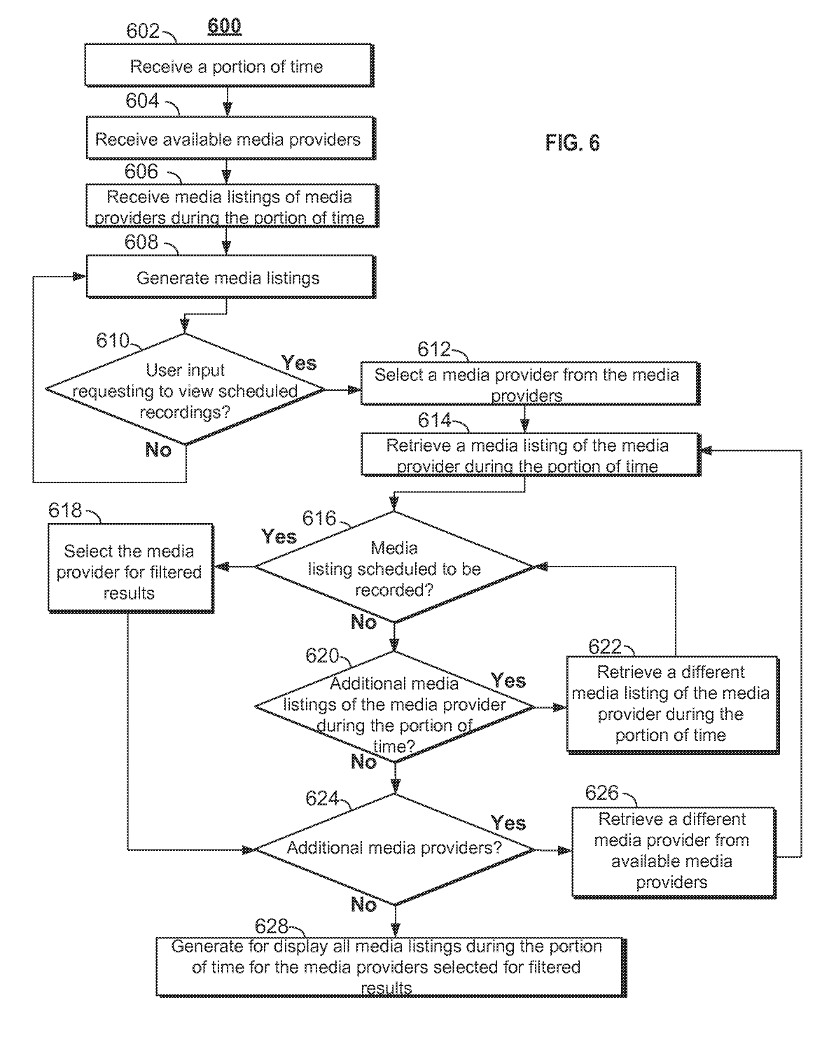

As shown in display 170 (and as further described in relation to process 600 (FIG. 6) below), the media guidance application may preserve the organization of the media guidance display, but remove media providers (e.g., media provider 134, 138, 140, and 142 (FIG. 1B)) that do not correspond to a media listing scheduled to be recorded during the portion of time. In display 170, only media listings for media providers 132 and 136 are shown indicating to a user that media providers 132 and 136 are associated with a media listing (e.g., media listing 144 and 148, respectively) that is scheduled to be recorded during the portion of time.

Display 170 also includes menu 168. Menu 168 represents additional options related to filtering media listings. For example, menu 168 includes a plurality of days for which a user may view media providers associated with media listings currently scheduled to be recorded. For example, menu option 172 is currently selected (e.g., as indicated by the highlight region about menu option 172) indicating that the media listings shown in display 170 correspond to a portion of time on “Friday.” In addition, menu option 172 includes indicator 174, which indicates that there are media listings scheduled for recording (and/or corresponding any other type of to scheduled event) on “Friday.”

It should be noted that although menu 169 is currently associated with days of the week, menu option 168 may additionally or alternatively be associated with any other criteria. For example, menu 168 may allow a user to sort media listings by time, month, genre, and/or any other characteristic associated with the user, media listing, and/or media asset. Additionally or alternatively, menu 168 may include one or more sub-menus. For example, in response to a user selection of menu option 172, the media guidance application may generate a new menu that includes additional menu options related to menu option 172.

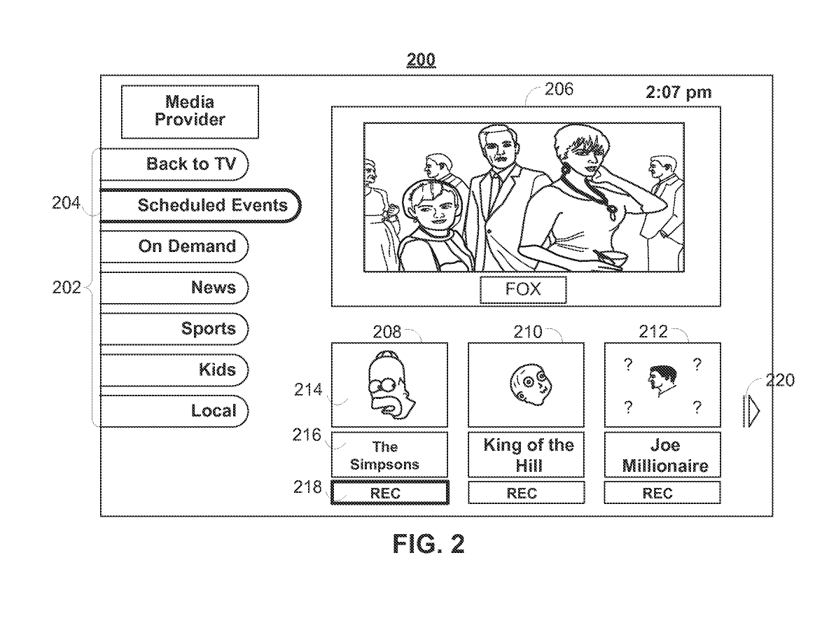

FIG. 2 shows another illustrative example of a media guidance display with a plurality of media listings that may be filtered. Video mosaic display 200 includes selectable options 202 for content information organized based on content type, genre, and/or other organization criteria. In display 200, selectable option 204 (“Scheduled Events”) is selected, thus providing media listings 206, 208, 210, and 212 as media listings for a media provider (e.g., “FOX”) that is associated with a media listing currently scheduled to be recorded.

For example, in display 200, because one of the media listings (e.g., media listing 208) for the media provider (“FOX”) is currently scheduled for recording (e.g., as indicated by highlighted recording box 218), media listings (e.g., media listing 206, 210, and 212) for the media provider are currently displayed.

Display 200 is not currently associated with a portion of time entered and/or request by a user. Therefore, the media guidance application has generated a default portion of time (e.g., starting at the current time (“2:07 PM” and proceeding in half-an-hour increments). Furthermore, as the programming of media listing 206 is currently in progress, display 200 displays the currently program in media listing 206.

In display 200, the listings may provide graphical representations of content such as graphical images including cover art, still images from the content, video clip previews, live video from the content, selectable options (e.g., in order to schedule a recording) or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data, information necessary for generating scheduled events, and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

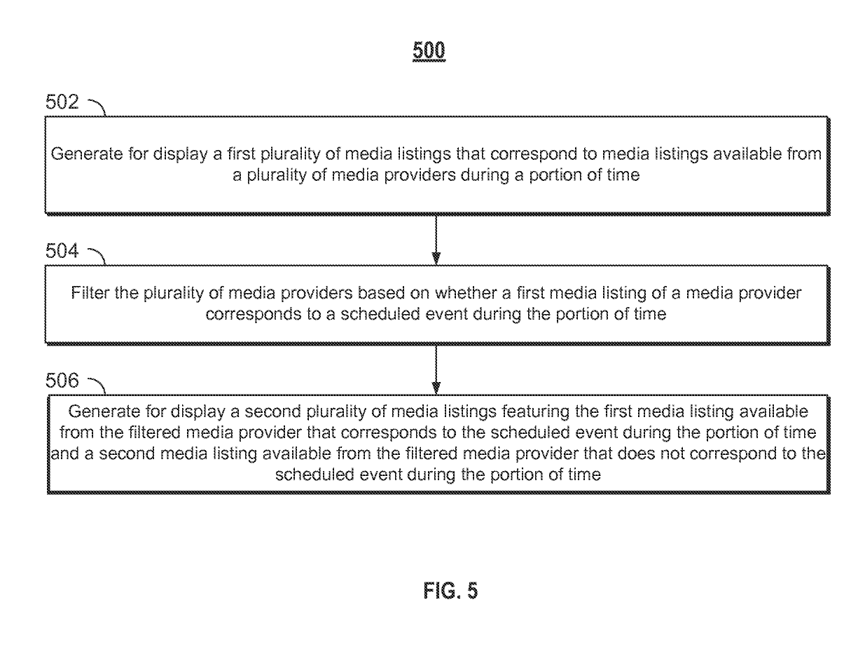

FIG. 5 is a flowchart of illustrative steps for generating a plurality of media listings that are filtered based on whether or not a media listing of a media provider corresponds to a scheduled event during the portion of time. For example, in some embodiments, process 500 generates a plurality of media listings resulting from one or more filtering operations. It should be noted that process 500 or any step thereof could be provided by any of the devices shown in FIGS. 3-4. For example, process 500 may be executed by control circuitry 304 (FIG. 3) as instructed by the media application.

At step 502, the media guidance application generates for display a first plurality of media listings that correspond to media listings available from a plurality of media providers during a portion of time. In some embodiments, the first plurality of media listings may correspond to display 130 (FIG. 1B)) as generated on a display screen (e.g., display 312 FIG. 3)) of a user device (e.g., user equipment 402, 404, and/or 406 (FIG. 4)). For example, in response to a user request to access a program guide, the media guidance application may generate for display a media guidance display (e.g., formatted as a media grid, mosaic screen, etc.) featuring one or more media listings associated with an available media asset.

In some embodiments, the media guidance display may organize available media listings according to one or more criteria. For example, the media listings may be organized according to presentation time, media provider, genre, user preferences, etc. Furthermore, the media guidance application may generate additional options for displaying media listings. For example, the media guidance application may provide the user with an option to filter media listings based on one or more criteria.

The media guidance application may organize the media listings and/or media guidance data in numerous ways. For example, the media listings and/or media guidance data may be organized in a media grid (e.g., featuring a first axis and a second axis corresponding to first and second criterion, respectively), or the media listings and/or media guidance data may be organized in a mosaic display (e.g., featuring a first area and a second area corresponding to first and second criterion, respectively).

At step 504, the media guidance application filters the plurality of media providers based on whether or not a first media listing of a media provider corresponds to a scheduled event during the portion of time. For example, filtering the media providers based on whether or not a first media listing of a media provider corresponds to a scheduled event during the portion of time may result in removing from display media providers that do not have a media listing scheduled to be recorded, a scheduled reminder, and/or any other scheduled event during the portion of time. Filtering media providers and/or media listings is further discussed in relation to process 600 (FIG. 6) below.

At step 506, the media guidance application generates for display a second plurality of media listings featuring the first media listing available from the filtered media provider that corresponds to the scheduled event during the portion of time and a second media listing available from the filtered media provider that does not correspond to the scheduled event during the portion of time. In some embodiments, the second plurality of media listings may correspond to display 170 (FIG. 1C) as generated on a display screen (e.g., display 312 FIG. 3)) of a user device (e.g., user equipment 402, 404, and/or 406 (FIG. 4)). For example, the media providers that are associated with the media listings that are generated for display are media providers that have media listings scheduled to be recorded during the portion of time.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order or in parallel or substantially simultaneously to reduce lag or increase the speed of the system or method.

FIG. 6 is a flowchart of illustrative steps for filtering a plurality of media listings based on whether or not a media listing of a media provider is scheduled to be recorded during the portion of time. For example, in some embodiments, process 600 may be used in process 500 (FIG. 5) to filter a plurality of media listings based on whether or not a media listing of a media provider is scheduled to be recorded during the portion of time. For example, step 504 (FIG. 5) may include one or more steps of process 600. It should be noted that process 600 or any step thereof could be provided by any of the devices shown in FIGS. 3-4. For example, process 600 may be executed by control circuitry 304 (FIG. 3) as instructed by the media guidance application.

It should be noted that process 600 may additionally or alternatively be used for filtering a plurality of media listings based on whether or not a media listing of a media provider corresponds to any type(s) of scheduled event. For example, in some embodiments, process 600 may be used to filter a plurality of media listings based on whether or not a media listing of a media provider is associated with a reminder during the portion of time.

At step 602, the media guidance application receives a portion of time. For example, in response to a user accessing a media guidance display feature of the media guidance application, the media guidance application may retrieve a portion of time defined by one or more increments of time (e.g., time increments 160, 162, and 164 (FIG. 1B)). The portion of time may be based on default portion of time (e.g., corresponding to a time beginning at the current time and extending a predetermined duration) and received as programming instructions from local (e.g., storage 308 (FIG. 3)) or remote storage (e.g., a database located at media guidance data source 418 and/or any location accessible via communications network 414 (FIG. 4)), or the portion of time may be based on a user input (e.g., received via user input interface 310 (FIG. 3)) defining a portion of time.

At step 604, the media guidance application receives available media providers. For example, the media guidance application may retrieve a list of all available media providers (e.g., media providers 132, 134, 136, 138, 140, and 142 (FIG. 1B)) from local (e.g., storage 308 (FIG. 3)) or remote storage (e.g., a database located at media content source 416, media guidance data source 418 and/or any location accessible via communications network 414 (FIG. 4)), or the media providers may be based on a user input (e.g., received via user input interface 310 (FIG. 3)) defining a criterion for displaying media providers (e.g., a user instruction to display only media providers associated with a sports category).

At step 606, the media guidance application receives media listings of the media providers during the portion of time. For example, the media guidance application may retrieve a list of the media listings that correspond to the media providers during the portion of time from local (e.g., storage 308 (FIG. 3)) or remote storage (e.g., a database located at media content source 416, media guidance data source 418 and/or any location accessible via communications network 414 (FIG. 4)). The media guidance application may use the media listings to populate a media guidance display.

At step 608, the media guidance application generates the media listings. For example, in some embodiments, the media guidance application may generate for display, on a display screen (e.g., display 312 FIG. 3)) of a user device (e.g., user equipment 402, 404, and/or 406 (FIG. 4)), a plurality of listings (e.g., media listings 144, 146, and 148 (FIG. 1B) as shown in display 130 (FIG. 1B)). In some embodiments, step 608 may correspond to step 502 (FIG. 5)).

At step 610, the media guidance application determines whether or not a user input requesting to view scheduled recordings is received. For example, the media guidance application may receive a user selection (e.g., via user input interface 310 (FIG. 3)) of an icon (e.g., option 166 (FIG. 1C)) to display only media providers associated with media listings currently scheduled to be recorded in a media guidance display.

If the media guidance application does not receive a user input requesting to view scheduled recordings, the media guidance application returns to step 608. If the media guidance application does receive a user input requesting to view scheduled recordings, the media guidance application proceeds to step 612. At step 612, the media guidance application selects a media provider from the available media providers. For example, if there are multiple media providers, the media guidance application selects the first media provider of the group.

At step 614, the media guidance application retrieves a media listing of the media providers during the portion of time. For example, if there are multiple media listings (e.g., a media listing corresponding to different time increments within the portion of time), the media guidance application selects the first media listing of the group.

At step 616, the media guidance application determines whether or not the selected media listing is scheduled to be recorded. If so, the media guidance application proceeds to step 618 and selects the media provider for the filtered results, and proceeds to step 624. For example, in response to determining that one of the media listings associated with the media provider during the portion of time is scheduled for recording, the media guidance application will include the media provider in the filtered results. In some embodiments, the filtered results may correspond to the second plurality of media listings described in step 506 (FIG. 5) and/or shown in display 170 (FIG. 1C).

In some embodiments, the media guidance application may determine whether or not a media listing is scheduled to be recorded based on cross-referencing the media listing with a database (e.g., located locally (e.g., on storage 308 (FIG. 3)) or remotely (e.g., at media content source 416, media guidance data source 418, and/or any other location accessible via communications network 414 (FIG. 4))) indicating the recording status of each media listing. For example, the database may monitor each scheduled recording made by a user device (e.g., user device 300 (FIG. 3)) and/or each scheduled recording associated with a user profile. If a recording of a particular media listing is scheduled, a record may be made in the database indicating that the media listing is scheduled to be recorded. The media guidance application (e.g., via control circuitry 304 (FIG. 3)) may then query the database to determine if the selected media listing is associated with a record indicating that the recording is scheduled.

If the media guidance application determines that the selected media listings is not scheduled to be recorded, the media guidance application proceeds to step 620 and determines whether or not there are any additional media listings of the media provider during the portion of time. For example, if the media provider is associated with two media listings during the portion of time, the media guidance application determines (e.g., via control circuitry 304 (FIG. 3)) if either of the media listings is scheduled to be recorded. If the first media listing is not scheduled to be recorded, the media guidance application proceeds to determine if the second media listing is scheduled to be recorded.

If the media guidance application determines that there are additional media listings of the media provider during the portion of time, the media guidance application proceeds to step 622, retrieves a different media listing of the media provider during the portion of time, and returns to step 616. If the media guidance application determines that there are not any additional media listings of the media provider during the portion of time, the media guidance application proceeds to step 624.

At step 624, the media guidance application determines whether or not there are any additional media providers. For example, the media guidance application (e.g., via control circuitry 304 (FIG. 3)) processes each media listing associated with each media provider. After processing all media listings for a first media provider, the media guidance application moves on to process the media listings for any other media providers. If the media guidance application determines (e.g., via control circuitry 304 (FIG. 3)) that there are additional media providers, the media guidance application proceeds to step 626, retrieves a different media provider from the available media providers, and returns to step 614. If the media guidance application determines (e.g., via control circuitry 304 (FIG. 3)) that there are no additional media providers, the media guidance application proceeds to step 628.

At step 628, the media guidance application generates for display all the media listings during the portion of time for the media providers of the filtered results. For those media providers, the media guidance application provides both media listings scheduled to be recorded and media listings not currently scheduled to be recorded. Advantageously, a user may then edit his/her scheduled recordings using an intuitive interface. In some embodiments, step 628 may correspond to step 506 (FIG. 5), and the media listings for the media providers of the filtered results may appear similar to display 170 (FIG. 1C) as generated on a display screen (e.g., display 312 FIG. 3)) of a user device (e.g., user equipment 402, 404, and/or 406 (FIG. 4)).

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for presenting media guidance data, the method comprising:
generating for display a first plurality of media listings, wherein the first plurality of media listings corresponds to media listings available from a plurality of media providers during a portion of time;
filtering the plurality of media providers corresponding to the first plurality of media listings based on whether a first media listing of the first plurality of media listings available from a media provider of the plurality of media providers corresponds to a scheduled event during the portion of time; and
generating for display a second plurality of media listings featuring results of the filtering, wherein the results of the filtering include the first media listing available from a filtered media provider that corresponds to the scheduled event during the portion of time and a second media listing available from the filtered media provider that does not correspond to the scheduled event during the portion of time.

2. The method of claim 1, further comprising generating the first plurality of media listings in a media grid.

3. The method of claim 2, wherein a first axis of the media grid corresponds to the plurality of media providers and a second axis of the media grid corresponds to the portion of time.

4. The method of claim 1, further comprising generating the first plurality of media listings in a mosaic display.

5. The method of claim 1, further comprising:
generating for display an option associated with a different portion of time; and
generating for display a third plurality of media listings, wherein the third plurality of media listings includes a third media listing available from a filtered media provider that corresponds to the scheduled event during the different portion of time and a fourth media listing available from the filtered media provider that does not correspond to the scheduled event during the different portion of time.

6. The method of claim 1, further comprising:
receiving a user selection of the second media listing available from the filtered media provider that does not correspond to the scheduled event during the portion of time; and
scheduling an event associated with the second media listing available from the filtered media provider that does not correspond to the scheduled event during the portion of time in response to the user selection.

7. The method of claim 1, wherein filtering the plurality of media providers includes removing from display media providers that do not have a media listing corresponding to the scheduled event during the portion of time.

8. The method of claim 1, wherein the first plurality of media listings is scrollable.

9. The method of claim 1, wherein the first media listing available from the filtered media provider that corresponding to the scheduled event during the portion of time includes a scheduling indicator and the second media listing available from the filtered media provider that does not correspond to the scheduled event during the portion of time does not include the scheduling indicator.

10. The method of claim 1, further comprising:
receiving a user filtering request; and
in response to the filtering request, filtering the plurality of media providers corresponding to the first plurality of media listings based on whether the media listing of the first plurality of media listings available from the media provider of the plurality of media providers corresponds to the scheduled event during the portion of time.

11. A system for presenting media guidance data, the system comprising control circuitry configured to:
generate for display a first plurality of media listings, wherein the first plurality of media listings corresponds to media listings available from a plurality of media providers during a portion of time;
filter the plurality of media providers corresponding to the first plurality of media listings based on whether a first media listing of the first plurality of media listings available from a media provider of the plurality of media providers corresponds to a scheduled event during the portion of time; and
generate for display a second plurality of media listings featuring results of the filtering, wherein the results of the filtering include the first media listing available from a filtered media provider that corresponds to the scheduled event during the portion of time and a second media listing available from the filtered media provider that does not correspond to the scheduled event during the portion of time.

12. The system of claim 11, wherein the control circuitry is further configured to generate the first plurality of media listings in a media grid.

13. The system of claim 12, wherein a first axis of the media grid corresponds to the plurality of media providers and a second axis of the media grid corresponds to the portion of time.

14. The system of claim 11, wherein the control circuitry is further configured to generate the first plurality of media listings in a mosaic display.

15. The system of claim 11, wherein the control circuitry is further configured to:
generate for display an option associated with a different portion of time; and
generate for display a third plurality of media listings, wherein the third plurality of media listings includes a third media listing available from a filtered media provider that corresponds to the scheduled event during the different portion of time and a fourth media listing available from the filtered media provider that does not correspond to the scheduled event during the different portion of time.

16. The system of claim 11 wherein the control circuitry is further configured to:
receive a user selection of the second media listing available from the filtered media provider that does not correspond to the scheduled event during the portion of time; and
schedule an event associated with the second media listing available from the filtered media provider that does not correspond to the scheduled event during the portion of time in response to the user selection.

17. The system of claim 11, wherein the control circuitry configured to filter the plurality of media providers is further configured to remove from display media providers that do not have a media listing corresponding to the scheduled event during the portion of time.

18. The system of claim 11, wherein the first plurality of media listings is scrollable.

19. The system of claim 11, wherein the first media listing available from the filtered media provider that corresponds to the scheduled event during the portion of time includes a scheduling indicator and the second media listing available from the filtered media provider that does not correspond to the scheduled event during the portion of time does not include the scheduling indicator.

20. The system of claim 11 wherein the control circuitry is further configured to:
receive a user filtering request; and
in response to the filtering request, filter the plurality of media providers corresponding to the first plurality of media listings based on whether the media listing of the first plurality of media listings available from the media provider of the plurality of media providers corresponds to the scheduled event during the portion of time.

21-40. (canceled)
